(19) United States
(12) Patent Application Publication
(10) Pub. No.: US 2004/0087214 A1
(43) Pub. Date: May 6, 2004

(54) Network adapter

(75) Inventor: Shih-Ming Cho, Ping Chen City (TW)

Correspondence Address: RABIN & BERDO, P.C., Suite 500, 1101 14 Street, N.W., Washington, DC, 20005, US

(73) Assignee: DOUBLE WIN ENTERPRISE CO., LTD, Ping Chen City (TW)

(21) Appl. No.: 10/286,876

(22) Filed: Nov. 4, 2002

(51) Int. Cl. H01R 25/00

(52) U.S. Cl. 439/638

(57) ABSTRACT

A network adapter device such as a modulation bridge is provided for establishing a home network. The device comprises a modulation bridge including a control chip assembly complied with HomePlug, a plurality of device ports wherein one is adapted to connect to a computer via a network line and the other one is adapted to connect to a peripheral via a USB line, a coaxial cable jack, a modular telephone jack, and a power cord jack. Thus, the invention can connect to a power cord, telephone line cord, or coaxial cable for effecting a data transmission between a computer and a peripheral or between computers in the home network.

### FIELD OF THE INVENTION

The present invention relates to network adapters and more particularly to an external network adapter (e.g., modulation bridge) having an arrangement capable of electrically connecting to indoor power cord, telephone line cord, or coaxial cable for data communication between a computer and a peripheral or between computers.

### BACKGROUND OF THE INVENTION

A family having two or more personal computers is not rare due to the advance of information and network technologies. It is more often that there are more than one computer installed in an office. Thus, techniques for connecting at least two computers together to establish a home or office network (called home network hereinafter) are available. It is anticipated that family members or office persons can access the internet via such mini network.

Currently, Ethernet, Home Phoneline Networking Alliance (HomePNA), wireless local area network (LAN), and HomePlug are employed by the home network. Existing indoor power cord or telephone line cord used as a transmission media is preferred because there is no need to wire again. Thus, constant improvements in the above fields are still be sought.

A 110 V or 220 V power cord is stipulated by HomePlug Powerline Alliance as a standard for home network communication media. This is because it is typical that at least one outlet is provided in a room. Hence, it is simple to connect a computer to an outlet via a power cord in the same room or the internet for data communication. However, high noise and susceptible of signal interference or decay is typical in the power cord. As such, signal quality is poor, resulting in an inhibition of further increase of data transmission rate. HomePlug Powerline Alliance published HomePlug 1.0 as a standard for first generation power cord based home network. The HomePlug 1.0 is designed to conform to data transmission via power cord. Ideally, a maximum 14 Mbps data transmission rate is possible. In practice, however, a data transmission rate of only 5 to 8 Mbps with a maximum transmission distance within 200 feet is obtained.

In another field, HomePNA aims at stipulating rules for telephone line cord based home network. In a typical implementation, a plurality of telephone line cords are interconnected between a RJ-11 modular wall jack having a plurality of ports, the same number as the telephone line cords and the a plurality of computers, the same number as the telephone line cords. This forms a home network. In use, a user simply connects a HomePNA plug attached to a computer to the modular wall jack prior to connecting to other computers or peripherals for communication. A data transmission rate of 1 Mbps is possible in the original HomePNA 1.0. In a later version of HomePNA 2.0 the data transmission rate is 10 Mbps within 300 feet. In a latest version of HomePNA 3.0, the data transmission rate has increased to about 100 Mbps. Both HomePNA 2.0 and HomePNA 3.0 have a higher data transmission rate and an undesired higher cost as compared with HomePNA 1.0. In a undesired case, both quality and speed of the data transmission are decreased if there are other signals (e.g., Asynchronous Digital Subscriber Line (ADSL) or exchange signals) are transferred on the telephone line cord.

Typically, data transmission quality is proportional to data transmission rate. As stated above, high noise and susceptible of signal interference is typical in the power cord. Hence, both reliability and transmission distance of HomePlug 1.0 are less than that of HomePNA 2.0. In an exceptional case when data transmission quality of power cord or telephone line cord is acceptably high the data transmission rate of HomePlug 1.0 about the same as that of HomePNA 2.0. In a more common case when high noise and susceptible of signal interference are occurred in power cord or telephone line cord such as one in a certain exchange, the data transmission rate of HomePlug 1.0 is higher than that of HomePNA 2.0. As to user convenience, the outlet is much better than the modular wall jack. As to cost, HomePNA 2.0 is higher than HomePlug 1.0. In view of above, HomePlug and HomePNA each has its advantages and disadvantages. Hence, it is hard for a user to decide whether HomePlug (power cord based one) or HomePNA (telephone line cord based one) should be used since neither can fulfill the user's requirement completely.

In a home network application, an Ethernet bridge has one end implemented as a power cord plug complied with HomePlug for connecting to an outlet by means of power cord. As such, data can be transmitted via the power cord. Alternatively, the Ethernet bridge has one end implemented as a modular telephone plug complied with HomePNA for connecting to a modular wall jack by means of telephone line cord. As such, data can be transmitted via the telephone line cord. However, both have their respective disadvantages. For example, HomePlug is only applicable to power cord based data transmission while HomePNA is only applicable to telephone line cord based data transmission. Hence, it is impossible to use a well known network adapter device to connect to either power cord or telephone line cord for carrying out either a power cord or telephone line cord based data transmission. In other words, there is no adaptability. Moreover, a coaxial cable is typical used for receiving programs via cable TV in home or office. The coaxial cable is a low interference media as compared with power cord or telephone line cord. In a current cable modem, 40 Mbps data transmission rate within several ten kilometers can be obtained by utilizing coaxial cable as transmission media. Its drawbacks are that expensive equipment in a central office is required for cooperation with the cable modem. This may increase cost borne on cable TV providers. Also, wiring of coaxial cable is relatively difficult. Hence, a coaxial cable based data transmission is still unavailable for the home network. Hence, improvements still exist.

### SUMMARY OF THE INVENTION

It is therefore an object of the present invention to provide a HomePlug based network adapter device for establishing a home network. The device has an arrangement capable of electrically connecting to a power cord, telephone line cord, or coaxial cable for effecting a power cord, telephone line cord, or coaxial cable based data transmission between a computer and a peripheral or between computers.

In one aspect of the present invention, a network adapter device is provided in a room having an embedded first telephone line cord and at least one modular wall jack coupled to the first telephone line cord. The device comprises a modulation bridge including a control chip assembly complied with HomePlug, a plurality of device ports wherein one is adapted to connect to a computer via a network line and the other one is adapted to connect to a peripheral via a USB line, a coaxial cable jack, a modular telephone jack, and a power cord jack; and a second telephone line cord having one end coupled to the modular telephone jack and the other end coupled to the modular wall jack.

In another aspect of the present invention, a network adapter device is provided in a room having an embedded coaxial cable. The device comprises a modulation bridge including a control chip assembly complied with HomePlug, a plurality of device ports wherein one is adapted to connect to a computer via a network line and the other one is adapted to connect to a peripheral via a USB line, a coaxial cable jack connected to the coaxial cable, a modular telephone jack, and a power cord jack.

In a further aspect of the present invention, a network adapter device comprises a modulation bridge including a control chip assembly complied with HomePlug, a plurality of device ports wherein one is adapted to connect to a computer via a network line and the other one is adapted to connect to a peripheral via a USB line, a coaxial cable jack, a modular telephone jack, and a power cord jack.

The above and other objects, features and advantages of the present invention will become apparent from the following detailed description taken with the accompanying drawings.

### BRIEF DESCRIPTION OF THE DRAWINGS

FIG. 1 is a perspective view taken from a forward angle of an external network adapter according to the invention;

FIG. 2 is a view similar to FIG. 1 taken from a rear angle;

FIG. 3 presents schematically the interconnection of computers and peripherals via a plurality of network adapters by means of telephone line cord for data transmission according to the invention;

FIG. 4 presents schematically the interconnection of computers and peripherals via a plurality of network adapters by means of coaxial cable for data transmission according to the invention; and

FIG. 5 presents schematically the interconnection of computers and peripherals via a plurality of network adapters by means of power cord for data transmission according to the invention.

### DETAILED DESCRIPTION OF THE PREFERRED EMBODIMENTS

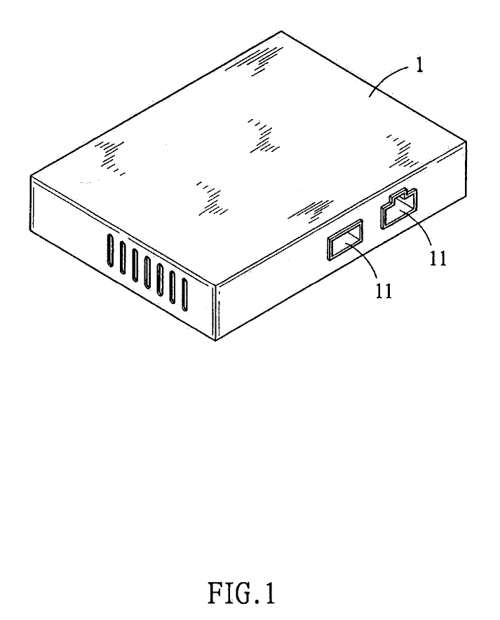

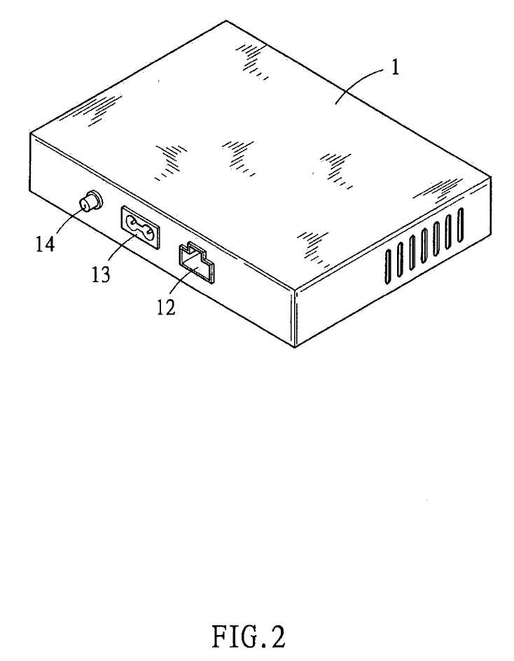

Referring to FIGS. 1 and 2, there is shown an external network adapter in accordance with the invention. The network adapter comprises a modulation bridge 1 including a control chip assembly complied with HomePlug 1.0, a plurality of front device ports 11 (two are shown) electrically connected to the control chip assembly in which one device port 11 is adapted to connect to a desktop or notebook computer via a network line and the other device port 11 is adapted to connect to a peripheral (e.g., printer or scanner) via a Universal Serial Bus (USB) line, and a modular telephone jack 12, a power cord jack 13, and a coaxial cable jack 14 all in the rear panel electrically connected to the control chip assembly. The modular telephone jack 12 is connected to a modular wall jack so as to communicate data via an existing telephone line cord. Likewise, the coaxial cable jack 14 is connected to a TV coaxial cable jack so as to communicate data via coaxial cable. The power cord jack 13 is connected to an indoor outlet so as to communicate data via power cord.

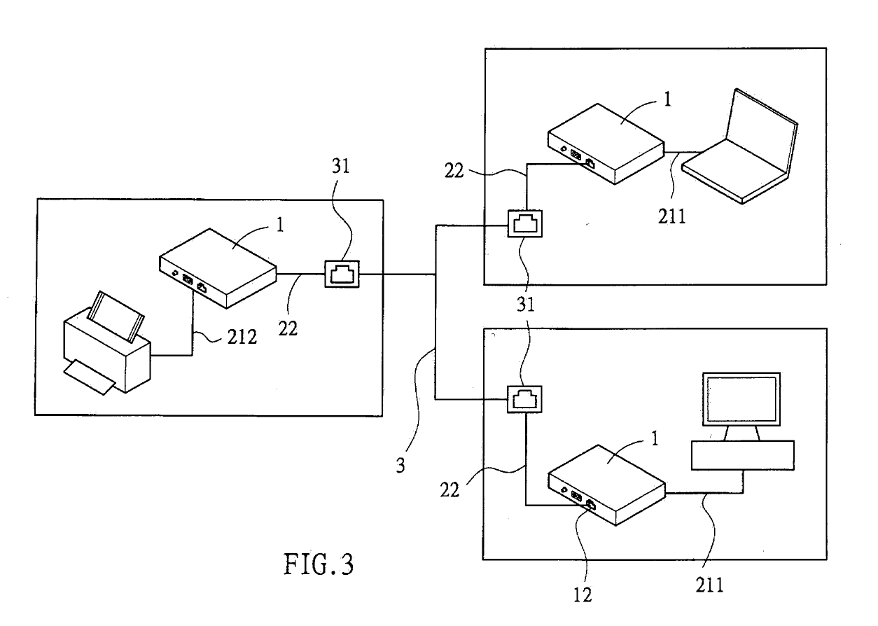

Referring to FIG. 3, in this connection a telephone line cord 3, at least one coupled modular wall jack (one is shown) 31, and a modulation bridge 1 are installed in each of a number of rooms (three are shown in block) of a home in which the modulation bridges 1 in the rooms are electrically connected. The modular telephone jack 12 connected to the modular wall jack 31 via a telephone line cord 22. The device port 11 is connected to a desktop or notebook computer via a network line 211. Alternatively, the device port 11 is connected to a printer or any of other network devices via a USB line 212. With this configuration, a plurality of computers and peripherals in different rooms are coupled together by the telephone line cord to establish a home network. Thus, data can be communicated between the computers and peripherals via the HomePlug based modulation bridges and the telephone line cord in a high rate with high quality.

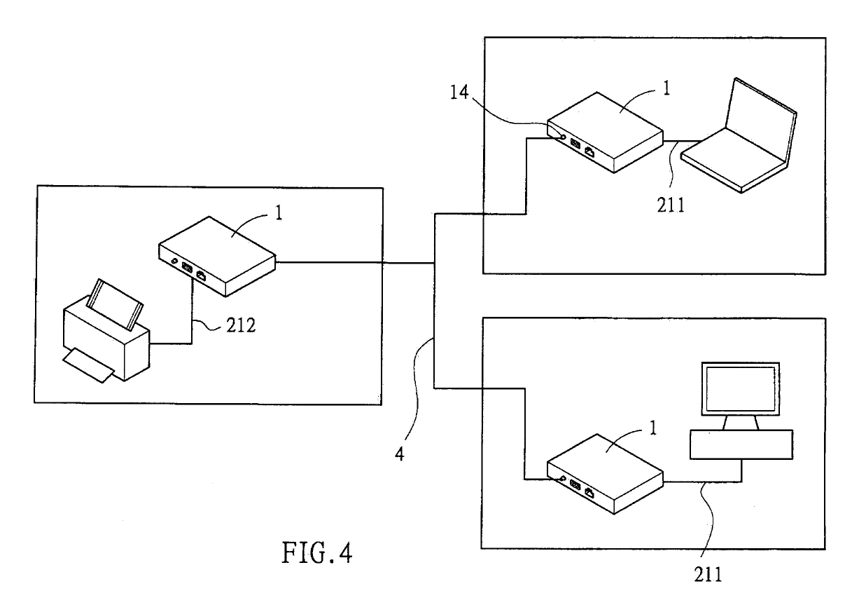

Referring to FIG. 4, in this connection a coaxial cable 4 and a modulation bridge 1 are installed in each room in which the modulation bridges 1 in the rooms are connected together by the coaxial cable 4. In detail, the coaxial cable jack 14 is connected to the coaxial cable 4. The device port 11 is connected to a desktop or notebook computer via the network line 211. Alternatively, the device port 11 is connected to a printer or any of other network devices via the USB line 212. With this configuration, a plurality of computers and peripherals in different rooms are coupled together by the coaxial cable 4 to establish a home network. Thus, data can be communicated between the computers and peripherals via the HomePlug based modulation bridges and the coaxial cable in a high rate with high quality.

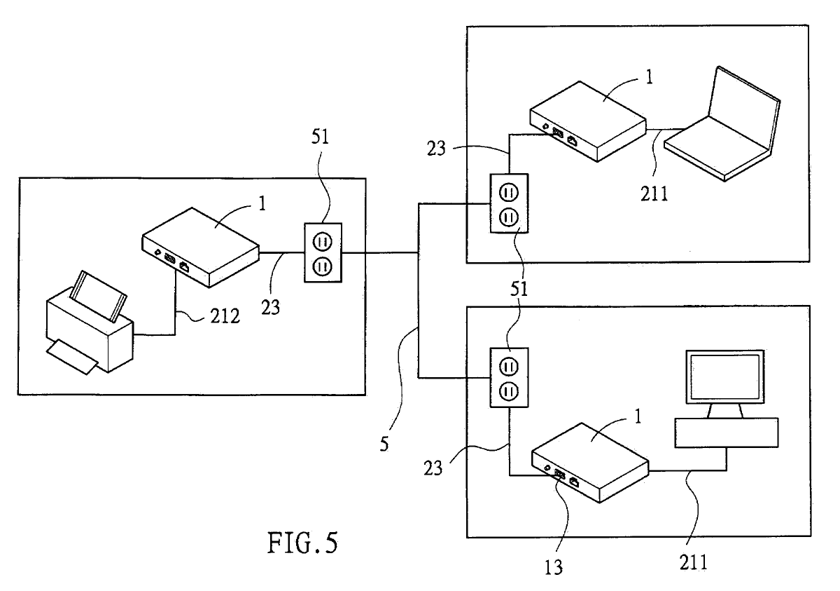

Referring to FIG. 5, in this connection a power cord 5, at least one coupled outlet (one is shown) 51, and a modulation bridge 1 are installed in each room in which the modulation bridges 1 in the rooms are electrically connected. In detail, the power cord jack 13 is connected to the outlet 51 via a power cord 23. The device port 11 is connected to a desktop or notebook computer via the network line 211. Alternatively, the device port 11 is connected to a printer or any of other network devices via the USB line 212. With this configuration, a plurality of computers and peripherals in different rooms are coupled together by the power cord to establish a home network. Thus, data can be communicated between the computers and peripherals via the HomePlug based modulation bridges and the power cord in a high rate with high quality.

It is believed that the modulation bridge of the invention is able to connect to power cord, telephone line cord, or coaxial cable for power cord, telephone line cord, or coaxial cable based data transmission by connecting the power cord jack, modular telephone jack, or coaxial cable jack to power cord, telephone line cord, or coaxial cable respectively. In other words, a great adaptability is achieved. Note that the modulation bridge may be implemented as an Ethernet or USB adapter.

While the invention has been described by means of specific embodiments, numerous modifications and variations could be made thereto by those skilled in the art without departing from the scope and spirit of the invention set forth in the claims.

What is claimed is:

1. A network adapter device provided in a room having an embedded first telephone line cord and at least one modular wall jack coupled to the first telephone line cord, the device comprising:
a modulation bridge including a control chip assembly complied with HomePlug, a plurality of device ports wherein one is adapted to connect to a computer via a network line and the other one is adapted to connect to a peripheral via a Universal Serial Bus (USB) line, a coaxial cable jack, a modular telephone jack, and a power cord jack; and
a second telephone line cord having one end coupled to the modular telephone jack and the other end coupled to the modular wall jack.

2. The device of claim 1, wherein the modulation bridge is an Ethernet adapter.

3. The device of claim 1, wherein the modulation bridge is a USB adapter.

4. A network adapter device provided in a room having an embedded coaxial cable, the device comprising a modulation bridge comprising a control chip assembly complied with HomePlug, a plurality of device ports wherein one is adapted to connect to a computer via a network line and the other one is adapted to connect to a peripheral via a Universal Serial Bus (USB) line, a coaxial cable jack connected to the coaxial cable, a modular telephone jack, and a power cord jack.

5. The device of claim 4, wherein the modulation bridge is an Ethernet adapter.

6. The device of claim 4, wherein the modulation bridge is a USB adapter.

7. A network adapter device comprising a modulation bridge including a control chip assembly complied with HomePlug, a plurality of device ports wherein one is adapted to connect to a computer via a network line and the other one is adapted to connect to a peripheral via a Universal Serial Bus (USB) line, a coaxial cable jack, a modular telephone jack, and a power cord jack.

8. The device of claim 7, wherein the modulation bridge is an Ethernet adapter.

9. The device of claim 7, wherein the modulation bridge is a USB adapter.
